(19) United States
(12) Patent Application Publication
(10) Pub. No.: US 2003/0202766 A1
(43) Pub. Date: Oct. 30, 2003

(54) Sealed package for optical component

(75) Inventors: Shimon Medalsy, Rishon LeZion (IL); Neil Berns, Jerusalem (IL)

Correspondence Address: Ladas & Parry, 26 West 61 Street, New York, NY, 10023, US

(73) Assignee: LYNX PHOTONIC NETWORKS INC.

(21) Appl. No.: 10/135,179

(22) Filed: Apr. 29, 2002

(51) Int. Cl. G02B 6/00

(52) U.S. Cl. 385/135; 385/134

(57) ABSTRACT

A protectively sealed package enclosing an optical component included in a light transmission system in which fiber-optics lines are connected to the component, the lines feeding through the package without breaking the seal. The package includes a tray to accommodate the optical component, a lid to close the tray, and a sealing unit formed of elastomeric material to define a loop and a jacket integral therewith. The sealing unit is sandwiched between the tray and the lid, the loop being seated on a ledge that runs along the rim of the tray and the jacket projecting outwardly therefrom. The jacket is provided with a duct through which extend the fiber-optics lines connected to the optical component, the duct being air-tight. When the lid is fastened to the tray it then compresses the loop therebetween to protectively seal the package.

### FIELD OF THE INVENTION

This invention relates generally to the packaging of an optical component included in a fiber-optics light transmission system for conveying light signals which are fed into the component for processing, and in particular to a package which is sealed to protect the component from a hostile environment.

### STATUS OF PRIOR ART

In a fiber-optics transmission system, light signals representing data and other information are conveyed via fiber-optics lines. These lines are connected to the terminals of optical components such as modulators, demodulators and terminal units. The optical components must be capable of operating properly for prolonged periods of time, often in a hostile environment damaging to the components, such as hot and humid air or a polluted atmosphere which corrodes the components.

Most optical components are resistant to a hostile atmosphere and can tolerate exposure thereto for a limited period. But not when a component is exposed to this atmosphere for a prolonged period. It is therefore a common practice to enclose a sensitive optical component in a sealed package. This package is essential to the long-term survival of the component and to its proper functioning.

The concern of the present invention is with a protective static seal for a package containing a fiber optics component in which the seal is constituted by a gasket of elastomeric material compressed between a tray in which the component is placed and a lid covering the tray. The nature of the seal depends on the degree of compression. When the gasket is lightly compressed, it then functions as a humidity seal forming a moisture barrier. But when the gasket is subjected to greater pressure, it then functions as an air-tight, hermetic seal that excludes air as well as moisture from the package.

In a typical installation, the package is situated in an atmosphere which is humid but not contaminated. Hence to protect the fiber optics component, it is only necessary to provide a humidity barrier. However, for long term protection, a hermetic seal may be preferable to exclude contaminated air as well as moisture from the package.

A typical hermetically-sealed package for an optical component includes a feed-through pipe to conduct the fiber-optics lines into the package to be connected to the terminals of the component housed in the package. The pipe is inserted into the package by means of a notch, a gap or other opening in the wall of the housing. In order therefore to fully seal the package, the pipe opening must also be sealed.

Thus, the 1999 U.S. Pat. No. 5,970,194 to Dunn provides a box housing an optical component having a feed through metal jacket fitted in a gap in the box through which extend the optical fibers to be connected to terminals of the optical component. To effect a hermetic seal, the jacket must be soldered to the gap.

In the 1997 Tanabe et al. U.S. Pat. No. 5,613,031, the optical fibers enter a box containing a component through a pipe inserted in a hole in the box, the pipe being soldered thereto. The lid of this box is welded thereto.

In the Sasaki U.S. Pat. No. 5,727,104, in order to effect a hermetic seal of a fiber-optics box, soldering paste is applied to the lid which is then soldered to the box. In Kovats U.S. Pat. No. 4,413,881, an optical fiber enters a box through a brass barrel that is soldered to a base in the wall of the box.

Of greatest prior art interest is the 1994 U.S. Pat. No. 5,313,546 to Toffetti in which optical fibers enter a box through a sealing gasket secured in a notch in a side wall of the box. The upper edge of the sealing gasket engages a separate O-ring gasket which is more rigid than the material of the notch gasket. The ring gasket is sandwiched between the rim of the box and the flange of its cover. But the notch gasket and the ring gasket in Toffetti are independent of each other and are not integrated into a unitary assembly. And the notch gasket in Toffetti must fit exactly into a notch in the wall of the box, this being a possible source of leakage.

Thus the prior art recognizes the need to protectively seal a package enclosing an optical component to which fiber-optics lines are connected in order to isolate the component from a hostile environment and it provides various forms of packaging for this purpose.

A major drawback of prior art packaging is that they all include a notch, a gap or an opening of some sort to accommodate a feed-through pipe or jacket for the fiber-optics lines to be connected to terminals of the component. This makes it necessary to seal the feed-through opening in the package as well as the closure for the box.

### SUMMARY OF THE INVENTION

In view of the foregoing, it is the main object of the invention to provide a sealed package for an optical component included in a light transmission system in which fiber-optics lines pass through the package to be connected to terminals of the component, the lines feeding through the package without breaking the seal.

More particularly, an object of this invention is to provide a package of the above type in which the component is housed within a tray covered by a lid and a sealing unit is compressed therebetween to effect a humidity or a hermetic seal.

Among the significant features of the invention are the following:

1st. Sealing of the package is effected by a sealing unit of elastomeric gasket material in which a continuous loop is integrated with a jacket which serves as a feed-through duct for the optical lines, this unit being all that is required to effect a seal of the package which protects the component therein.

2nd. No notch or other opening is required in the package to enable feed through of the fiber-optics lines; hence the integrity of the package structure is not disturbed.

3rd. No soldering or other expedients are necessary to effect sealing of the package.

4th. In order to effect protective sealing, it is only necessary to sandwich and compress a sealing unit between a tray containing the optical component and a lid covering the tray, hence the package can be quickly assembled.

Also an object of the invention is to provide a sealing unit to seal an optical component having input and output terminals, the unit being formed by a continuous loop having a pair of jackets integrated therewith on opposite sides of the loop, one jacket feeding fiber-optics lines to the input terminals, the other jacket feeding lines to the output terminals.

Briefly stated, these objects are attained by a sealed package enclosing an optical component included in a light transmission system in which fiber-optics lines are connected to the component, the lines feeding through the package without breaking the seal.

The package includes a tray to accommodate the optical component, a lid to close the tray, and a sealing unit formed of elastomeric material to define a continuous loop and a jacket integral therewith. The sealing unit is sandwiched between the tray and the lid, the loop being seated on a ledge that runs along the rim of the tray with the jacket projecting outwardly therefrom. The jacket is provided with a duct through which extend the fiber-optics lines connected to terminals of the optical component, the duct being rendered air-tight. When the lid is fastened to the tray it then compresses the loop therebetween to seal the package. Depending on the degree of compression, the seal functions either as a humidity or a hermetic seal.

### BRIEF DESCRIPTION OF THE DRAWINGS

For a better understanding of the invention as well as other objects and features thereof, reference is made to the annexed drawings wherein:

FIG. 1 is a perspective view of a sealed package enclosing an optical component in accordance with the invention;

FIG. 2 is an exploded view of the package;

FIG. 3 shows in plan view the sealing unit included in the package;

FIG. 4 is an end view the jacket of the sealing unit;

FIG. 5 is a section taken through a corner of the package to show how the sealing unit is compressed between the lid and tray of the package; and

FIG. 6 shows a sealing unit adapted to feed fiber-optics lines to an optical component having input and output terminals at opposed positions thereon.

### DETAILED DESCRIPTION OF THE INVENTION

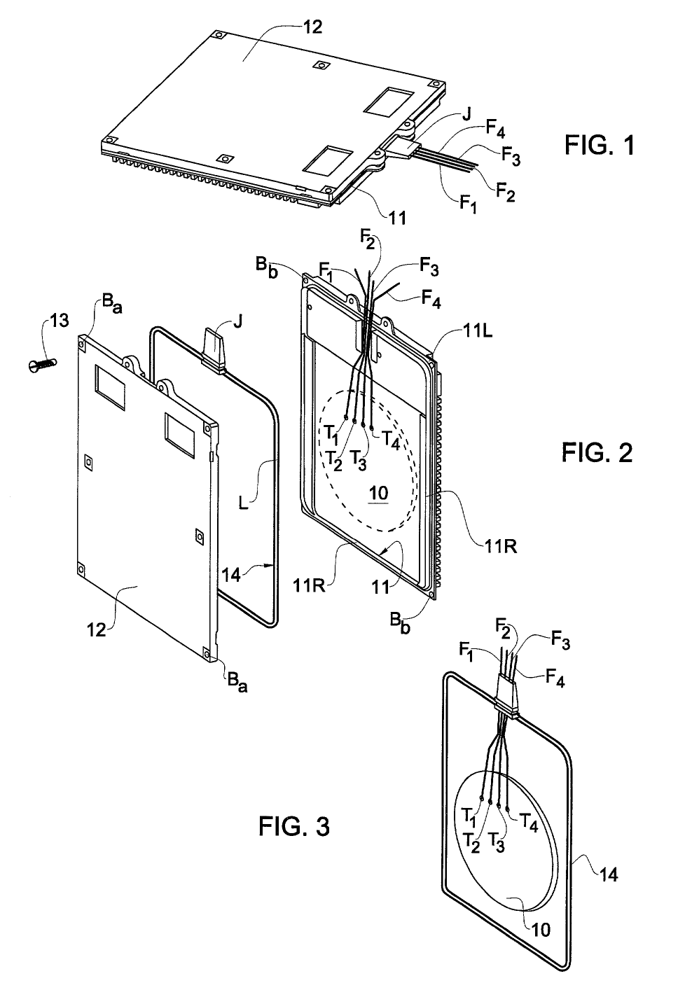

First Embodiment: Referring now to FIGS. 1 to 5 shown in these figures is a protectively-sealed package in accordance with the invention enclosing a disc-shaped optical component 10. This component is included in a light transmission system in which fiber optics lines F1, F2, F3 and F4 are connected to terminals T1, T2, T3 and T4 on the optical component. The number of lines and terminals shown are by way of example only, and in practice the number can be smaller or greater.

A typical optical component acts to process light signals passing therethrough and is therefore provided with input terminals to which incoming lines are connected and output terminals to be connected to outgoing lines. In the optical component shown in FIG. 2, terminals T1 and T2 are input terminals connected to input fiber-optics lines F1 and F2, while terminals T3 and T4 are output terminals connected to output lines F3 and F4. These four terminals are in a single row on one side of the component.

The package is constituted by three main elements:

(One) a shallow rectangular tray 11 which accommodates an optical component 10 so that its terminals T1 to T4 are adjacent the front end of the tray,

(Two) a rectangular lid 12 which covers the tray and is fastened thereto by screws 13, and

(Three) a sealing unit 14 interposed between the tray and the lid, the unit being compressed when the lid is attached to the tray to effect a hermetic seal of the package.

The rectangular rim 11L of the tray is in the form of a continuous flat ledge whose inner boundary is defined by a rail 11R to create a seating surface for seating the sealing unit 14. This unit which is molded of an elastomeric material such as neoprene or a synthetic rubber of the type suitable for gaskets and O-rings, is formed by a generally rectangular loop L having four branches that rest on corresponding branches of rim 11L and a jacket J integral with the front end branch of the loop. Hence when loop L is seated on rim 11L and abuts rail 11R, jacket J then projects out of the package, as best seen in FIG. 1.

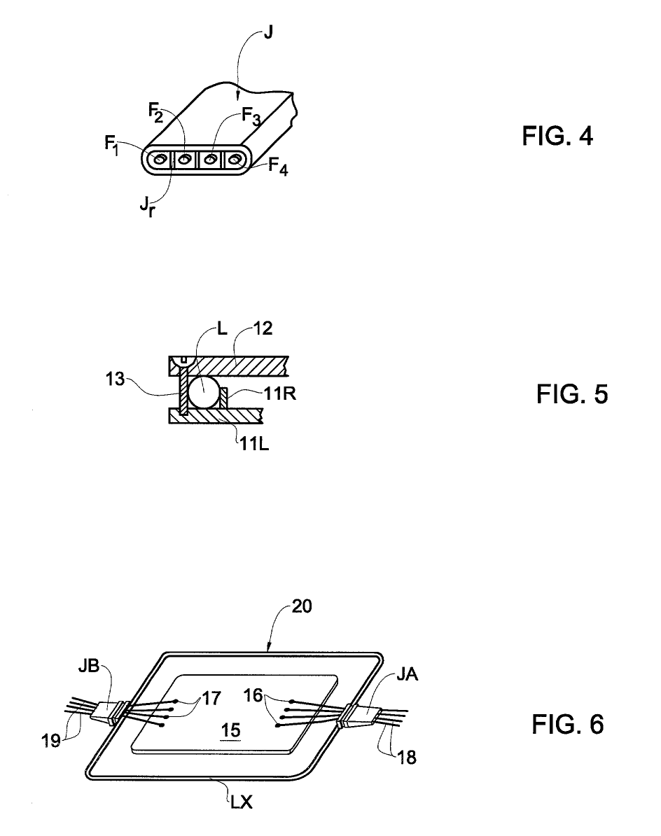

As shown in FIG. 4, jacket J is divided by parallel ribs Jr into four channels through which extend the four fiber-optics lines F1 to F4. These lines as shown in FIG. 3, pass through the jacket to be connected to terminals T1 to T4 of optical component 10.

When loop L of the sealing unit 14 is seated on rim 11R of tray 11 and the tray is covered by lid 12, it is then sandwiched between the periphery of the tray and the corresponding periphery of the lid. Screws 13 are inserted in bores Ba in the four corners of lid 12 and are turned into threaded bores Bb in the four corners of rim 11L. The screws are then tightened to subject the sealing unit 14 to compression, the compressed unit then sealing the package except to the extent that there is air leakage in the duct of jacket J. To obviate this leakage, injected into the duct of jacket J is a bonding agent such as an epoxy that bonds the fiber lines going through the duct to each other and to the jacket whereby it is then air tight.

As previously noted, the degree to which sealing unit 14 is subjected to compression determines whether the unit acts as a humidity seal which only excludes moisture from the package, or as a hermetic seal which also excludes air. The degree of compression is determined by the extent to which screws 13 are tightened.

It is a simple matter to assemble the package. First the optical component 10 is placed in tray 11 and fiber-optics lines F1 to F4 are extended through jacket J and connected to terminals T1 to T4 of the component. Then loop L of the sealing unit is seated on rim 11L of the tray so that jacket J then sticks out of the front end lo of the tray. Lid 12 is then put on the tray and fastened thereto by screws 13. These screws are tightened to compress the elastomeric loop L of the sealing unit, thereby hermetically sealing the package. Finally a bonding agent is injected into jacket J which when it hardens renders it air tight.

The package illustrated in the figures makes use of a shallow tray for a disc-shape optical component. But in practice the geometry of the package depends on that of the optical component to be housed therein and it therefore need not be rectangular or shallow and may assume many other forms in which the sealing unit has a corresponding geometry.

Second Embodiment: This embodiment which is shown in FIG. 6 is tailored to provide a protectively sealed package for a square optical component 15 having a row of four input terminals 16 at the front end thereof and a row of four output terminals 17 at the rear end thereof. Connected to input terminals 16 are four fiber-optics lines 18 which convey light signals to be processed into optical component 15. And connected to output terminal 17 are four fiber-optics lines 19 to convey the processed light signals out of the package.

The tray and lid to enclose optical component 15 may be similar to those shown in FIGS. 1 and 2. However, the sealing unit 20 which is to be interposed between the tray and lid is designed to cooperate with the input and output terminals 16 and 17 of the component. The sealing unit 20 which is formed of elastomeric material includes a rectangular loop LX having at its front end branch a jacket JA through which extend input lines 18 connected to input terminals 16.

Integral with the rear end branch of loop LX is a jacket JB through which extend the output lines 19 connected to output terminals 17. When an optical component has more than one set of terminals at different positions therein, each requiring a different set of lines connected thereto, then a sealing unit appropriate to such a component would include a jacket reserved for each set of lines.

It is to be noted that the geometry of gasket or sealing unit depends on the geometry of the tray, and that since in the example illustrated, the tray is lo rectangular, so is the unit. But in practice, the geometry of the tray may not be rectangular in which case the sealing unit will have a geometry that conforms to that of the tray and is not rectangular.

While there has been shown preferred embodiments of the invention, it is to be understood that many changes may be made therein without departing from the spirit of the invention.

1. A protectively sealed package enclosing an optical component to be included in a light transmission system having fiber-optics lines which are connected to terminals in the component; said package comprising:
1st. a tray to accommodate the component, said tray having a rim provided with a continuous seat;
2nd. a sealing unit formed of elastomeric material which defines a continuous loop that is seated on the rim of the tray, said tray being integrated with a jacket that projects outwardly from the rim, said jacket having a duct through which the lines extend to be connected to said terminals;
3rd. a lid for closing the tray whereby the sealing unit seated on the rim is then sandwiched between the lid and the tray; and
4th. fastening means to attach the lid to the rim which when tightened act to compress the sealing unit to seal the package.

2. A package as set forth in claim 1 in which the loop and the jacket are molded of synthetic, plastic, elastomeric material whereby the loop is integral with the jacket.

3. A package as set forth in claim 2 in which the material is neoprene.

4. A package as set forth in claim 1 in which the rim and the seat therein are rectangular in form and the loop has a like configuration.

5. A package as set forth in claim 4 in which the component is disc shaped and is provided with a row of terminals adjacent the jacket.

6. A package as set forth in claim 4 in which the fastening means are screws that go through holes in the corners of the lid and are threadably received in bores at the corners of the rim.

7. A package as set forth in claim 1 in which the duct in the jacket is divided to form a separate channel for each fiber passing therethrough.

8. A package as set forth in claim 7 in which the duct is filled with a bonding agent to bond the fibers to each other and to the jacket to exclude air from the duct.

9. A package as set forth in claim 1 in which said component has a set of input terminals on one side thereof and a set of output terminals on the opposite side, and said sealing unit includes a second jacket through which extends fibers to be connected to said output terminals.

10. A package as in claim 1 in which the unit is compressed to a degree causing it to function as a humidity seal excluding moisture from the package.

11. A package as in claim 1 in which the unit is compressed to a degree causing it to function as an air-tight hermetic seal.
